(19) United States
(12) Patent Application Publication
(10) Pub. No.: US 2014/0204954 A1
(43) Pub. Date: Jul. 24, 2014

(54) COMMUNICATIONS GATEWAY FOR TRANSMITTING AND RECEIVING INFORMATION ASSOCIATED WITH AT LEAST ONE SERVICE CLASS

(71) Applicant: VERAX TECHNOLOGY HOLDINGS, INC., Norwell, MA (US)

(72) Inventor: Patrick Joseph Nee, Hanover, MA (US)

(73) Assignee: VERAX TECHNOLOGY HOLDINGS, INC., NORWELL, MA (US)

(21) Appl. No.: 14/161,201

(22) Filed: Jan. 22, 2014

Related U.S. Application Data
(60) Provisional application No. 61/755,228, filed on Jan. 22, 2013.
(60) Provisional application No. 61/792,332, filed on Mar. 15, 2013.
(60) Provisional application No. 61/825,619, filed on May 21, 2013.
(60) Provisional application No. 61/877,403, filed on Sep. 13, 2013.

(51) Int. Cl. H04L 12/851; H04L 12/725

(52) U.S. Cl. CPC H04L 47/2441; H04L 45/30
USPC 370/401

(57) ABSTRACT

An apparatus disclosed includes a memory and at least one processor in communication with the memory. The at least one processor configured to: i) identify a service class of a plurality of service classes associated with data received at an interface of the apparatus; and ii) map the data to at least one communication port based on the service class.

### RELATED APPLICATION(S)

This application claims the benefit of U.S. Provisional Application No. 61/755,228, filed on Jan. 22, 2013, U.S. Provisional Application No. 61/792,332, filed on Mar. 15, 2013, U.S. Provisional Application No. 61/825,619, filed on May 21, 2013 and U.S. Provisional Application No. 61/877,403, filed on Sep. 13, 2013. The entire teachings of the above application(s) are incorporated herein by reference.

### BACKGROUND

A gateway is an entrance point from one network to another network. Sometimes a gateway must convert one protocol stack into another. In most data networks, the flow of data across the network will terminate in either a gateway node or host (end-point) node. Both the computers of Internet users and the computer servers that generate web pages are examples of host nodes, while the nodes that interconnect networks are gateways.

Specialized routers can often be configured as gateways although other devices can also function as a gateway. A router by itself can transfer, accept and relay packets of information but only within a network using the same set of protocols throughout. However a gateway can generally accept a packet formatted for one protocol and convert it to another protocol format. A protocol translation/mapping gateway interconnects networks with different network protocol technologies by performing the required protocol conversions to ensure system interoperability. Typically a gateway is implemented in both hardware and software, but they are often implemented by special software installed within a router.

One of the most important functions of a gateway is to isolate a network owned by one entity (residential user, private company, common carrier, etc) from a network owned by a different entity. Gateways ensure that customer/carrier data is protected from external threats and that only approved customer/operator information leaves its own network. A gateway may provide capabilities to do protocol translation, packet filtering, rate adaptation, as well as authentication, authorization and accounting. Gateways often ensure that traffic that is leaving its network and will pass through an untrusted network on its way to its destination is transmitted through secure tunnels.

### SUMMARY

Embodiments of the present disclosure include methods, systems, and apparatus for processing information associated with at least one service class of a plurality of service classes. One embodiment is an apparatus that includes a memory and at least one processor in communication with the memory. The at least one processor is configured to: i) identify a service class of a plurality of service classes associated with data received at an interface of the apparatus; and ii) map the data to at least one communication port based on the service class.

The at least one communication port can be assigned to transmit and receive information corresponding to a first subject service class of the plurality of service classes. Also, the at least one processor can be further configured to assign the at least one communication port to transmit and receive information corresponding to the first subject service class based on an access network of a plurality of distinct access networks from which the at least one communication port is configured to transmit and receive information.

In addition, the at least one processor can be configured to identify the service class of the plurality of service classes associated with the data based on information extracted from the data. Further, the at least one communication port can be configured to transmit and receive information corresponding to a second subject service class of the plurality of service classes in response to an event occurring over a communication port initially assigned to transmit the information corresponding to the second subject service class.

Another embodiment is a method, executed by at least one processor, for processing information associated with a service class. The method includes: i) identifying the service class of a plurality of service classes associated with data received at an interface of a communication device; and ii) mapping the data to at least one communication port of the communication device based on the service class.

### BRIEF DESCRIPTION OF THE DRAWINGS

The foregoing will be apparent from the following more particular description of example embodiments of the disclosure, as illustrated in the accompanying drawings in which like reference characters refer to the same parts throughout the different views. The drawings are not necessarily to scale, emphasis instead being placed upon illustrating embodiments of the present disclosure.

FIG. 1 is a block diagram of a gateway in accordance with an example embodiment of the present disclosure.

FIG. 2 is a network diagram illustrating radio paths for terrestrial and satellite communications in accordance with an example embodiment of the present disclosure.

FIG. 3 is a flow chart of an example method for processing information associated with a service class.

### DETAILED DESCRIPTION

A description of example embodiments of the disclosure follows. Embodiments of the present disclosure relate to a gateway system than can be utilized by, for example, businesses. The disclosed gateway is a single system that provides access to the outside world for all of the needs of small businesses at a particular location. For example, the gateway supports telephony, fire alarms, burglar alarms and surveillance, remote metering, as well as all of the business-specific needs, e.g., POS (Point-of-Sale), inventory lookup, EAS (Electronic Article Surveillance) for retail stores, general Internet access, etc.

Inherent to the gateway system is an extremely high reliability of data transfer using a redundant processor, backup battery, and multiple physically distinct paths from the gateway to network-based application servers and the SIP servers of the VoIP service provider.

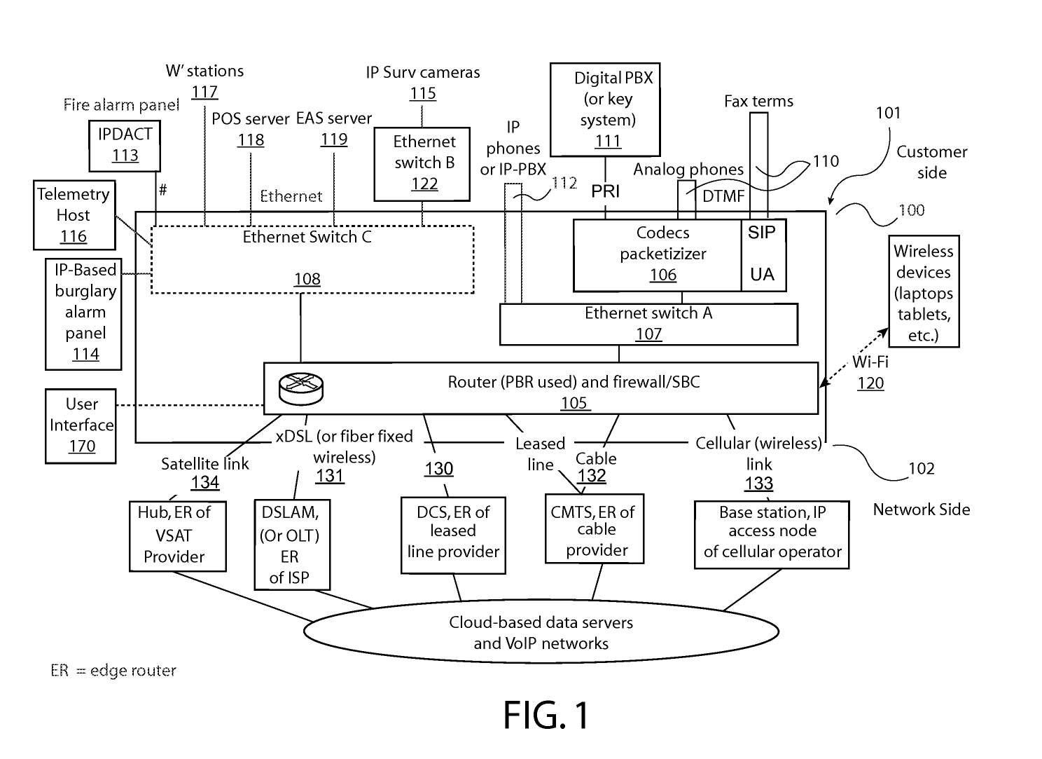

FIG. 1 illustrates a gateway 100 that includes a router 105, telephony-band audio codecs with packetizer for audio and fax signals 106, and at least one Ethernet switch 107. A second Ethernet switch 108 may be needed to aggregate Ethernet traffic depending on the configuration. The router 105 and the packetizer 106 each include at least one processor and memory.

The gateway router 105 also includes a firewall or session border controller (SBC) to protect all customer devices, functions and data (not shown). The firewall/SBC includes a Network Address Translator (NAT) which maps the network IP addresses (one per path) to the servers and IP end-systems (wired and wireless) on the customer side of the gateway 101. To support security, the firewall also provides stateful inspection of all packets incoming from the network side 102. If SBC functionality is included, this can be used to support VoIP and fax over IP calls through SIP normalization, prioritization of emergency calls, etc. An SBC is required (not optional) if the IP-PBX or IP phones use some other signaling protocol besides standard SIP.

The gateway 100 also provides fault tolerance and most importantly automatic battery backup—needed in case of power failure. All processors of the gateway (embedded in 105, 106) are fully redundant and all internal paths within the gateway are duplicated. The gateway 100 supports PoE (Power over Ethernet) over all connected Ethernet Cat 3 and Cat 5 cables, e.g., to IP phones, external Ethernet switches, etc.

The gateway 100 also includes a user interface 170 which may be used to customize the allocation of traffic classes to different paths, and for assignment of failover paths for each of the traffic classes. This interface can also be used to download updates of the gateway software from a network-based server.

Customer data (e.g., configuration of the traffic flows on the network paths) and any other data on the gateway can be backed up locally on an external drive or remotely on a network server.

The codecs and packetizer 106 supports a wide range of narrowband audio codecs, e.g., G.711 (g-law PCM), G.729A, iLBC and possibly other popular VoIP codecs such as SILK, G.723.1, Speex and GSM AMR. Transcoding of speech signals is also supported (if needed).This module 106 also supports the conversion of each fax to one or more images. The T.38 protocol is used for transmitting fax across the IP network to another fax terminal or a fax server, which can then deliver the fax in many different ways. Fax traffic is handled in the same way as telephony (VoIP) traffic in terms of access to the network.

The role of Ethernet switch A 107 is to aggregate all VoIP traffic; the role of switch C 108, if present, is aggregation of Ethernet data traffic.

The gateway 100 processes traffic received from a customer side 101 to appropriate pathways on a network side 102 according to traffic routing policies which is described in greater detail below.

The interfaces on the customer side 101 support at least one of the following technologies: Ethernet, Wi-Fi, Foreign Exchange Service (FXS) and Primary Rate ISDN (PRI). These technologies are used over at least one of connections 110-120. FXS ports 110 support traditional analog phones, analog fax machines or analog modems along with associated Dual Tone Multi-Frequency (DTMF) signaling. The PRI port 111 supports the network (trunk) side of a digital PBX or key system along with associated Q.931 signaling. Ethernet ports support VoIP phones or an IP-PBX 112, and many other IP-based devices and applications, including but not limited to:
fire alarm panels with attached IPDACT (IP Digital Alarm Communicator Transmitter) systems 113,
IP-based burglary alarm panels 114,
surveillance cameras (traffic usually aggregated with an Ethernet switch) 115
aggregated telemetry traffic 116
workstations 117
   as well as business-specific systems, for example:
IP-based POS servers 118
IP-based EAS servers 119
   Wi-Fi supports use of wireless laptops, tablets and other user devices on an internal WLAN 120

The network side 102 includes at least one of the following connections 130-134:
data connection from a leased-line 130 (copper and/or fiber);
data connection from a non-cable ISP 131 (xDSL or fiber);
data connection from a cable ISP 132 (DOCSIS-based);
data connection from a cellular provider (GPRS, HSPA, HRPD or LTE based 133); and
data connection from a VSAT service provider 134.
   The data rate provided by each of these paths is contingent on the amount of traffic to be carried and how the customer wishes to configure traffic flows across these paths.

With respect to the leased-line data connection path 130, the path can be configured to use leased facilities from a landline telco operator or a Virtual Private Network (VPN) service provider. This Internet leased line (also known as a dedicated internet access (DIA) line) can physically terminate at a router in the telco's central office, via a cross connect. To support a T-1, fractional T-1 or higher rate connection, the gateway 100 can include a CSU/DSU. Leased facilities can be appropriately conditioned copper cable (2-wire or 4-wire), fiber or a combination of the two. Data rates are generally symmetric and may range from 1.54 Mbps (for DS-1/T-1) to 45 Mbps (for a DS-3/T-3). Even higher rates over copper or fiber are possible using Gigabit Ethernet standards.

With respect to the non-cable Internet Service Provider (ISP) data connection path 131, the path 131 can be configured to be an xDSL (Digital Subscriber Line) connection and can also physically terminate at a DSLAM (DSL Access Multiplexer) located in a telco's central office. To support an xDSL connection, the gateway can include an appropriate xDSL modem. The physical connection can be standard twisted pair (copper). In some cases, the xDSL connection may terminate in a cabinet somewhere in the outside plant; fiber (in a FTTN (Fiber to the Node) configuration) is then used to connect the DSLAM back to the edge router in the central office facility. DSL data rates depend on the actual DSL technology and distance customer premises is from the central office or DSL termination point, and can range up to 100 Mbps downstream. In some cases, this connection may be fiber (e.g., Verizon FiOS®) in a FTTP (Fiber to the Premises) configuration. Verizon FiOS uses separate wavelengths for telephony, TV signals, and the Internet using a Passive Optical Network (PON) architecture from an OLT (Optical Line Termination) in a central office to an ONT (Optical Network Termination) in the VERAX gateway. Another potential connection path from the local telephone operator is a fixed wireless connection (e.g., an example of a fixed wireless connection is “Voice Link®” from Verizon although this product currently supports only analog telephony service, i.e., DSL is not supported).

With respect to the cable ISP data connection path 132 the path can be configured to be a HFC (Hybrid Fiber Coax) connection and can physically terminate at a CMTS (Cable Modem Termination System) located in a cable company's headend or hubsite. To support cable access, the gateway can include a cable modem. A media path can be the HFC connection. Also, downlink data rates up to 400 Mbps are possible for business customers.

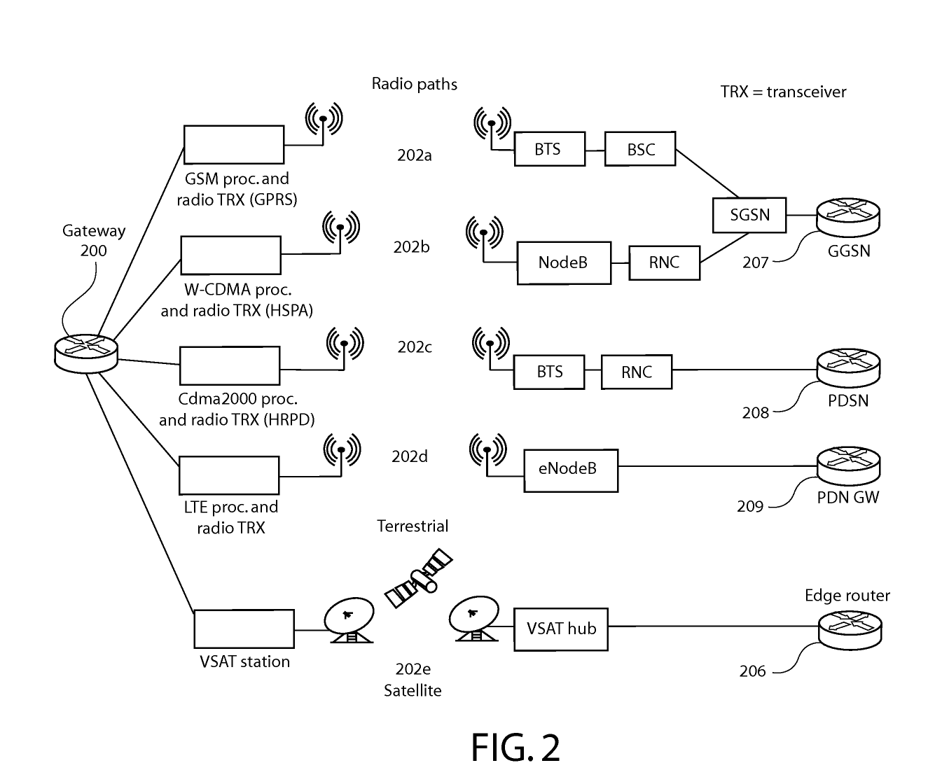

With respect to the cellular wireless provider data connection path 133, the gateway 100 can include an appropriate RF (Radio Frequency) transceiver and baseband processor along with a SIM card (baseband processor carries out channel coding and other processing); this path is of course wireless and can physically terminate at a base station (via an antenna at a cellular tower). Data access using different cellular technologies are possible:
GPRS (General Packet Radio Service) data service using GSM (Global System for Mobile Communications) (data rates up to 140 kbps downlink);
HSPA (High Speed Packet Access) using W-CDMA (data rates up to 14 Mbps downlink);
HRPD (High Rate Packet Data) (aka EV-DO) using cdma2000 (data rates up to 14 Mbps downlink); or
4G data service using LTE (Long Term Evolution) (data rates up to 300 Mbps downlink).
   The RF frequencies used depend on the particular wireless technology used. FIG. 2 provides more detail on these paths.

With respect to the VSAT (Very Small Aperture Terminal) data connection path 134, the gateway 100 can connect to a VSAT earth station on the customer's premises. The satellite connection terminates in a master (or hub) earth station which has a high-speed connection to an edge router of the VSAT service provider. Most VSAT providers use the Ku-band frequency band: 12-14 GHz. Data rates supported range from 56 kbps to 4 Mbps.

It should be noted that the number of output paths from the gateway is not limited to five (as illustrated in FIG. 1). In fact, it is possible to have multiple instances of PSTN-based ISPs or cellular providers. In other embodiments, the gateway can have a maximum of three or four paths. Further, these paths 130-134 all terminate in at least four physically distinct locations, i.e., PSTN central office(s), cable television head-end, cellular base station, or VSAT hub; this physical diversity is fundamental to ensuring protection in case of failure. Furthermore, with one exception, all of these paths are completely passive, i.e., no electronics and thus have no power requirements, between the customer premises and the central office or headend facility. The one exception is the case where a DSLAM is housed in a cabinet in an outside plant.

IP flows associated with each of the paths 130-140 connect with edge routers in a telco network, a Public Switched Telephone Network (PSTN)-based ISP, a cable network, a VSAT provider, or an IP access node in the case of cellular access. In the latter case, the access node would be either a Gateway GPRS Support Node (GGSN) (for GPRS or High Speed Packet Access (HSPA)), a Packet Data Service Node (PDSN) (for High Rate Packet Data (HRPD)), or a Packet Data Network (PDN) Gateway (for LTE).

The multiple paths 130-134 potentially support all of the following: automatic failover from one path to another; load sharing across these paths; and customer-selective assignment of different flows to different paths, e.g., VoIP over one path, critical data (e.g., alarms) over another, and non-critical data over a third path.

The gateway 100 provides integrated access for telephony services and data services across these multiple access paths. These multiple paths 130-134 provide access to the Session Initiation Protocol (SIP)-based services of a Voice over IP (VoIP) provider (unless the customer has a digital Private Branch Exchange (PBX) in its facility) and cloud-based data servers. For those customers without an existing PBX on site, a VoIP service provider can support a hosted IP-based PBX solution. In both cases, the VoIP service provide can terminate all SIP calls destined for the PSTN or a Public Land Mobile Network (PLMN) (e.g., Verizon Wireless®) on a media gateway close to a terminating network.

A number of the data services, especially critical services such as alarms and surveillance, as well as business-specific services (e.g., POS transactions) require a high degree of security, e.g., confidentiality and message integrity. This security is provided by the use of IPsec tunnels from the gateway router 105 to the various servers in the network.

FIG. 2 is a network diagram illustrating radio paths 205a-e for terrestrial and satellite communications. This set of paths corresponds to connections 133, 134 in FIG. 1. Edge router 206 or IP access nodes 207, 208, 209 are connected to the Internet for both data services and telephony services.

As stated herein, embodiments of the present disclosure relate to methods and apparatus for processing information associated with at least one service class. For example, if gateway 100 enables communications between many different and distinct service providers of a customer. For example, the gateway 100 is configured to support a range of service classes that include at least one of: telephony traffic, fax traffic, critical data traffic (fire alarms and burglary alarms), signaling traffic for telephony, real-time video (e.g., from IP-based surveillance cameras) and general data traffic (POS flows for retail outlets, metering data, etc.).

Many of the service classes are associated with similar traffic types. In particular, the traffic types have the following relative requirements: critical data traffic has a requirement of guaranteed delivery in a reasonable timeframe; telephony (carried as VoIP) has strict delay and low jitter requirements; fax has a low loss (addressed by the T.38 protocol) and a reasonably low delay requirement; VoIP signaling also has the requirement of guaranteed delivery; the delay and jitter requirements for the real-time video are expected to below than that those for telephony. In fact, requirements are likely to be similar to those streaming video over the Internet. Probably the most important requirements of business data traffic are reliability of delivery and security.

For analog phones, the codecs/packetizer module 106 is configured to support Dual Tone Multi-Frequency (DTMF) signaling. A SIP User Agent acts as a proxy for individual phones in accessing softswitch-based calling features (provided by a VoIP service provider). For analog phones, the same module 106 provides the ATA (Analog Telephone Adapter) function with a wide range of codecs supported.

For a digital PBX or key system, PRI signaling is supported; in this case, all calling features are provided by the PBX. The SIP User Agent in 106 represents each output digital channel from the PBX, not individual users; just VoIP transport is provided by the VoIP service provider for each of the channels. For a digital PBX or key system, 106 provides the media gateway function with the same wide range of codecs supported. For analog phones and fax terminals, each phone and terminal can be assigned a unique private IP address (behind the firewall); similarly, each PRI channel from the PBX or key system can be assigned a unique IP address.

A range of audio codecs is provided to support transport of audio packets across the network of the preferred VoIP provider and those of any other VoIP service provider. Note that the VoIP service provider should support one or more of the codecs used by the gateway, as a call may terminate on the PSTN.

The gateway 100 supports both a Hosted VoIP solution (in conjunction with a VoIP service provider) and an IP-PBX solution (using the customer's IP-PBX, digital PBX or key system).

All VoIP packets originating in module 106 can use UDP as the transport protocol. SIP signaling messages originating in 106 may use TCP, UDP or SCTP depending on what transport protocols are supported by the VoIP service provider (hosted VoIP solution) or the terminating signaling gateways (IP-PBX solution).

It is assumed that all other traffic types (with the exception of DTMF and Q.931 signaling) enter the gateway as Ethernet frames carrying IP packets.

For all these other traffic types, IPsec tunnels are provided from the gateway router 105 to the appropriate server. Ideally, a central monitoring system should be used for surveillance, fire alarms, burglar alarms, and metering, although of course separate servers may also be used. IPsec tunnels are also provided to all business-specific servers.

The gateway router 105 is also configured to maintain continuous ongoing IP connections with multiple access networks (e.g., ISP, cable provider, leased-line provider, cellular provider, etc). In other words, the gateway router 105 has multiple output links each identified by a different IP address (each of these addresses is provided by the appropriate service provider).

For each of these paths, the end-user flows enter the Internet at a different edge router. However, the data services terminate at appropriate cloud-based servers. (Note for business applications these servers may not reside in the “cloud”, i.e., they may instead reside on a LAN belonging to the enterprise.) Under normal conditions, traffic in the reverse direction exits the Internet at the same edge routers.

SIP servers of a VoIP service provider manage the end-to-end flows of telephony and fax traffic. If these calls are destined for PSTN or PLMN-based users, the calls terminate in media gateways close to those users. If these calls are destined for users with IP phones or ATAs, then the calls terminate on the user devices.

Under normal conditions, the flow of traffic across the multiple output paths can be customized according to the customer's preferences. These are some of the options available:
All traffic can use one of the paths with one or more alternate paths available for support of automatic failover; with this option, it is possible to give priority to different service classes, e.g.,
   priority 1—critical data traffic
   priority 2—VoIP signaling traffic
   priority 2—VoIP transport traffic
   priority 4—other data traffic
Load sharing across multiple (i.e., two or more) paths may be used
Different flows may be assigned to different paths, e.g.,
   VoIP traffic to cable provider
   critical data traffic (i.e., alarms) to leased line
   etc.
Different combinations of the above are also possible.

The flow of IP traffic across the multiple paths is not only customizable, but is reconfigurable. This reconfiguration of the IP traffic flows may be carried out by the customer locally (using the gateway's user interface 170) or remotely.

A capability to manage the flow of IP packets from the gateway across specific paths can be achieved through policy-based routing (PBR). Most router vendors support PBR which in effect overrides conventional routing protocols such as BGP. In general, with policy routing, the routing decision can be based on the source or destination IP addresses, port numbers, and MAC addresses.

In one example, a customer wishes to send all critical data on Path A; all voice, fax and associated SIP signaling on Path B; all surveillance traffic (streamed video) on Path C; and all other data traffic on Path D.

In the gateway router 105, PBR is implemented by inspecting both the source IP address and the source MAC address of each incoming packet. For illustration purposes, policy routing may act in the following manner:
If the IP address is the IP address of the IPDACT 113 or the IP-based burglary alarm panel 114, the packet is routed on Path A;
If the MAC address is the MAC address of the VoIP switch 107, the packet is routed on Path B
If the MAC address is the MAC address of an external Ethernet switch 122 in FIG. 1, which corresponds to the streaming video traffic, the packet is routed on Path C;
For all other addresses, the packet is routed on Path D.

Note that Paths A through D can be combined in a wide variety of ways to meet the customer's requirements. For example, the paths specified by the alarms and VoIP may be identical.

For each of the paths, the gateway router 105 will have a distinct IP address (provided by the ISP, wireless operator, etc.). Thus, for the various applications using these paths (VoIP, fire alarms, surveillance monitoring, general Internet and business applications) the gateway has a different IP address and thus the incoming packets will use the same path as the outgoing packets.

To ensure that this approach to path assignment functions correctly, it is necessary that the gateway 100 assigns static private IP addresses to both the IPDACT 113 and the burglary alarm panel 114. All other addresses may be assigned dynamically using DHCP.

Under normal conditions, the IP traffic flows operate across one or more paths 102. Each of these paths are not only logically separate but—generally speaking—terminate in physically distinct systems, i.e., central office, cable headend, cellular base station (or NodeB for W-CDMA access, or eNodeB for LTE access). The one possible exception is in the termination of DSL-based ISP and leased line paths; to ensure physical diversity in this case, it is necessary that these paths terminate in different central offices.

As stated before, the gateway router 105 maintains IP connections across multiple paths even if there is no active traffic flow on some of these paths under normal operating conditions. Under normal conditions, the gateway router 105 continually contacts the edge routers on each of the paths to ensure that IP connectivity is being maintained.

To ensure minimum disruption in the case of a failed path, the PBR only moves the traffic on the affected path to an alternate path. None of the other traffic flows are impacted.

As described above, just four service classes have been identified: critical data, VoIP, streaming video and other data. However, the customer has significant flexibility in the definition of the service classes via the user interface to the gateway. The number of service classes defined by the user is not restricted in any way.

To support automatic failover, a set of alternate paths for each of the service classes can be pre-specified. For example, for traffic of class i, we may specify the failover policy as A->B->C->D. In other words, Path A is specified as the primary path with Path B as the backup; if Path B is not available (i.e., has also failed), then the traffic should be moved to Path C; and so on.

On the other hand, the failover policy for traffic of class j might be B->D->A->C with a similar interpretation. Again, the failover policy may be configured locally or remotely by the customer.

When the gateway 100 has determined that a failure has occurred on one of the paths, the routing policy is reviewed and modified where necessary. When a failed path is restored, the routing policy for each traffic type is reviewed once again. Modifying these policies in either case is equivalent to updating routing tables.

As discussed earlier, critical data (e.g., fire alarms) requires highly reliable delivery more than anything else. This can be supported by transmitting this data simultaneously over multiple paths. This replication of data is unlikely to have significant impact on the overall amount of data carried by the access networks as critical data like this has low volume and is highly bursty.

In one embodiment the gateway 100 is configured to use different paths for individual telephony calls; however, the same access path is used for the duration of any particular call, as SIP requires the same IP address to be used under normal operation. In the case of failover, SIP can change of course one of the key characteristics of the session, namely, the IP address of the gateway, by sending a re-INVITE message on the failover path.

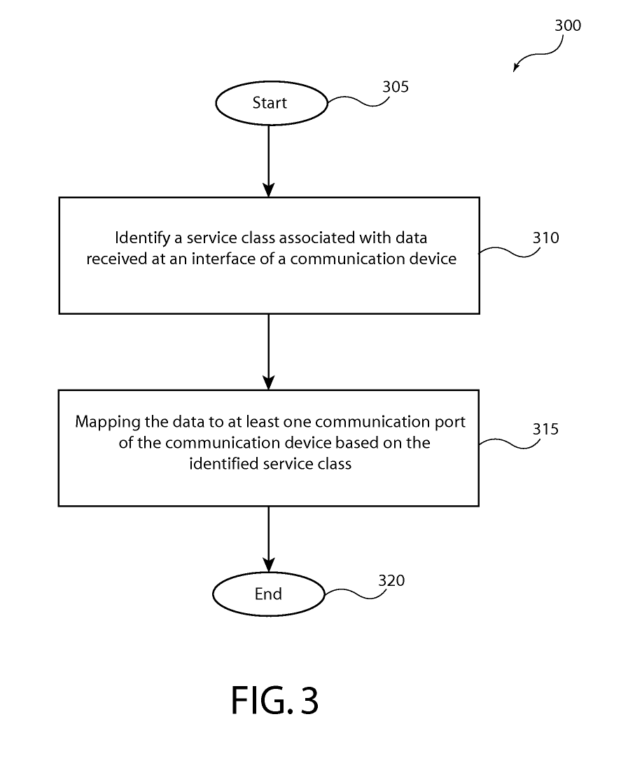

FIG. 3 illustrates a method 300 for processing information by, for example, the router 105 of FIG. 1, based on a service class associated with the information. The method 300 begins at 305. At 310, the method includes identifying a service class of a plurality of service classes associated with data received at an interface of a communication device (e.g., gateway 100 of FIG. 1). In particular, the method, at 310, can include identifying the service class of the plurality of service classes associated with the data based on information extracted from the data. At 315, the method includes mapping the data to at least one communication port of the communication device 102 based on the identified service class. The method, at 315, can also include assigning the at least one communication port to transmit and receive information corresponding to a first subject service class of the plurality of service classes. Further, the method 300, at 315, can include assigning the at least one communication port to transmit and receive information corresponding to the first subject service class based on an access network of a plurality of distinct access network from which the at least one communication port is configured to transmit and receive information.

As discussed above, policy based routing (PBR) provides one embodiment of this method.

In the case of a failover of a communication port 102, the method 300, at 315, can include, via the at least one communication port, transmitting and receiving information corresponding to a second subject service class of the plurality of service classes in response to an event occurring over a communication port initially assigned to transmit the information corresponding to second subject service class.

The teachings of all patents, published applications and references cited herein are incorporated by reference in their entirety.

While this disclosure has been particularly shown and described with references to example embodiments thereof, it will be understood by those skilled in the art that various changes in form and details may be made therein without departing from the scope of the disclosure encompassed by the appended claims.

What is claimed is:

1. An apparatus comprising:
a memory; and
at least one processor in communication with the memory, the at least one processor configured to:
identify a service class of a plurality of service classes associated with data received at an interface of the apparatus;
map the data to at least one communication port based on the service class.

2. The apparatus of claim 1 wherein the at least one communication port is assigned to transmit and receive information corresponding to a first subject service class of the plurality of service classes.

3. The apparatus of claim 2 wherein the at least one processor is further configured to assign the at least one communication port to transmit and receive information corresponding to the first subject service class based on an access network of a plurality of distinct access networks from which the at least one communication port is configured to transmit and receive information.

4. The apparatus of claim 1 wherein the at least one processor is further configured to identify the service class of the plurality of services classes associated with the data based on information extracted from the data.

5. The apparatus of claim 1 wherein the at least one communication port is configured to transmit and receive information corresponding to a second subject service class of the plurality of service classes in response to an event occurring over a communication port initially assigned to transmit the information corresponding to the second subject service class.

6. A method, executed by at least one processor, for processing information associated with a service class, the method comprising:
identifying the service class of a plurality of service classes associated with data received at an interface of a communication device; and
mapping the data to at least one communication port of the communication device based on the service class.

7. The method of claim 6 further comprising assigning the at least one communication port to transmit and receive information corresponding to a first subject service class of the plurality of service classes.

8. The method of claim 7 further comprising assigning the at least one communication port to transmit and receive information corresponding to the first subject service class based on an access network of a plurality of distinct access networks from which the at least one communication port is configured to transmit and receive information.

9. The method of claim 6 further comprising identifying the service class of the plurality of services classes associated with the data based on information extracted from the data.

10. The method of claim 6 further comprising, via the at least one communication port, transmitting and receiving information corresponding to a second subject service class of the plurality of service classes in response to an event occurring over a communication port initially assigned to transmit the information corresponding to the second subject service class.
